(19) United States
(12) Patent Application Publication
(10) Pub. No.: US 2017/0118168 A1
(43) Pub. Date: Apr. 27, 2017

(54) COMPUTER AND NETWORK ATTRIBUTE SETTING METHOD

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventors: DAN-DAN LI, Shenzhen (CN); QIU-JIE LEI, Shenzhen (CN)

(21) Appl. No.: 14/928,609

(22) Filed: Oct. 30, 2015

(30) Foreign Application Priority Data
Oct. 22, 2015 (CN) 201510687630.5

(51) Int. Cl. H04L 29/12; H04L 29/08

(52) U.S. Cl. CPC H04L 61/2092; H04L 67/36; H04L 61/2038

(57) ABSTRACT

A network-capable computer includes an internet jack, a detecting module, a storage module, and a network attribute setting module. The detecting module detects a connected network cable enables the computer to connect successfully to a network. The storage module stores IP addresses of a plurality of network cables. As stored data, the IP addresses includes an external static IP address and an IP address of a local area network. The network attribute setting module sets the static IP address or a dynamically accessed IP address within the local area network as a network attribute until the IP address of the computer connects successfully. A network attribute setting method is also provided.

### CROSS-REFERENCE TO RELATED APPLICATIONS

This application claims priority to Chinese Patent Application No. 201510687630.5, filed on Oct. 22, 2015, the contents of which are incorporated by reference herein.

### FIELD

The subject matter herein relates to a computer networking.

### BACKGROUND

Computers can connect to network cables to communicate with other devices. Network cables may have different domains. When one network cable connects to a computer, an internet protocol address (IP address) of the computer may be set by a user to a static address. When another network cable connects to the computer, an IP address of the computer may be set by the user to a dynamic address obtained by itself.

### BRIEF DESCRIPTION OF THE DRAWINGS

Implementations of the present technology will now be described, by way of example only, with reference to the attached figures.

FIG. 1 is a block diagram of a computer, according to an exemplary embodiment.

FIG. 2 is a block diagram of a computer, according to another exemplary embodiment.

FIG. 3 is a flowchart of a network attribute setting method, according to an exemplary embodiment.

FIG. 4 is a flowchart of a network attribute setting method, according to another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

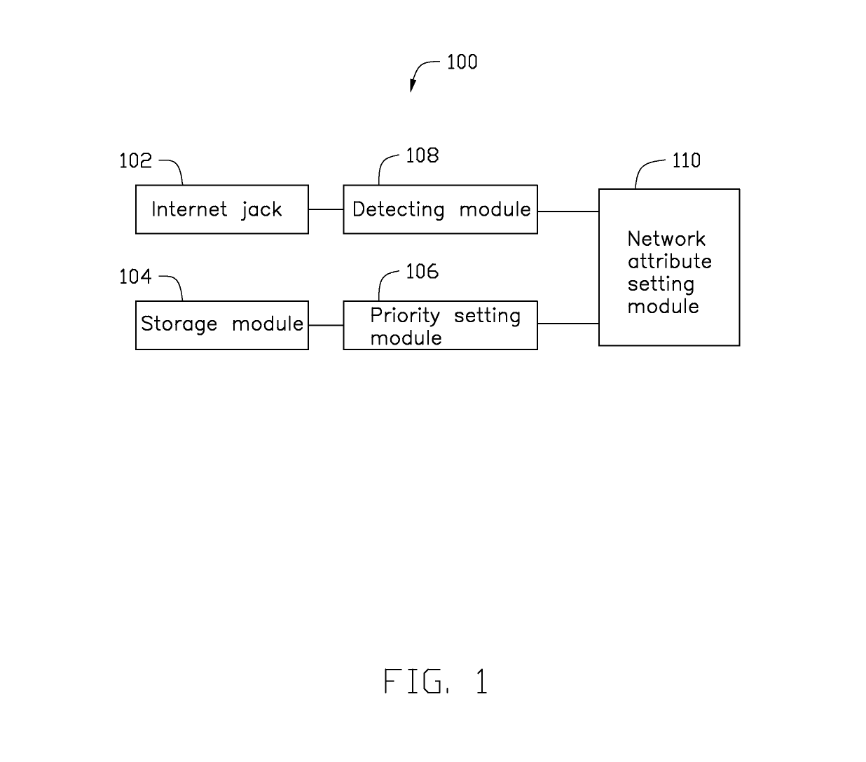

FIG. 1 illustrates a computer 100 according to an exemplary embodiment. The computer 100 includes an internet jack 102, a storage module 104, a priority setting module 106, a detecting module 108, and a network attribute setting module 110.

The internet jack 102 connects to a network cable. The storage module 104 stores IP addresses of a plurality of network cables. The stored data concerning IP addresses includes a static IP address and an IP address of a local area network. The static IP address is outside the local area network. The priority setting module 106 can configure the computer 100 to first use the static IP address or to first use the IP address of a local area network.

The detecting module 108 detects whether a network cable connects to the internet jack 102. The IP address of the network cable can be the static IP address or can belong to the local area network.

When a network cable connects to the internet jack 102, according to the IP address which is first used, the network attribute setting module 110 sets an IP address of the computer 100, as a network attribute, to the static IP address or to an IP address of the local area network which is dynamically accessed. The detecting module 108 further detects whether the set IP address of the computer 100 connects successfully. When the set IP address of the computer 100 does not connect, the network attribute setting module 110 sets the network attribute IP address of the computer 100 to an IP address of the local area network which is dynamically accessed or to the static IP address. When the network attribute IP address of the computer 100 is set to the static IP address and the computer 100 does not connect, the network attribute setting module 110 sets the IP address of the computer 100 to be dynamically accessed within the local area network. When the address of the computer 100 is set to be dynamically accessed within the local area network and the computer 100 does not connect, the network attribute setting module 110 sets the IP address of the computer 100 to the static IP address as a network attribute.

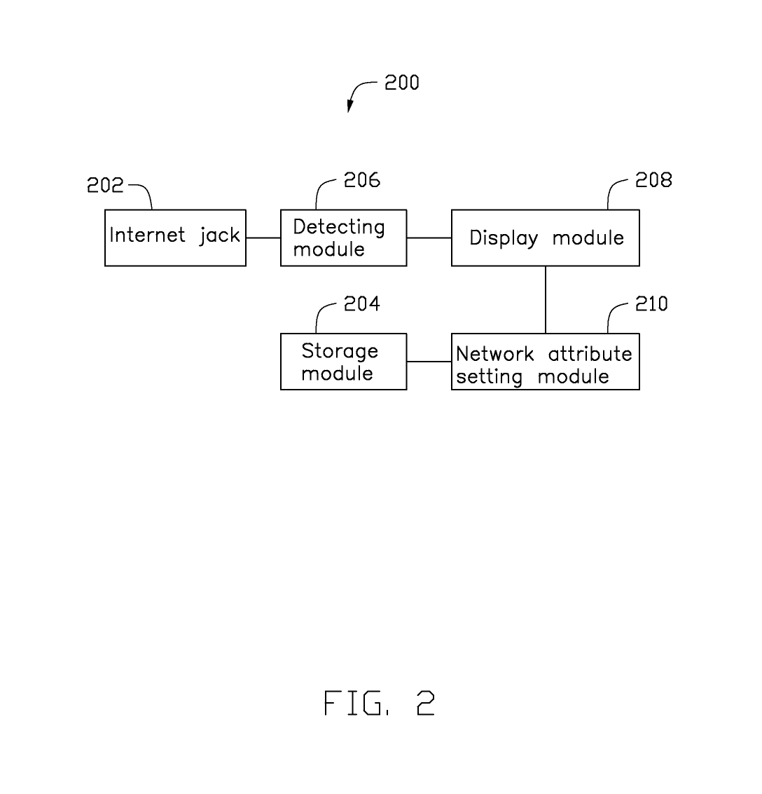

FIG. 2 illustrates a computer 100 according to another exemplary embodiment. The computer 200 includes an internet jack 202, a storage module 204, a detecting module 206, a display module 208, and a network attribute setting module 210.

The internet jack 202 connects to a network cable. The storage module 204 stores IP addresses of a plurality of network cables. The stored data including IP addresses includes a static IP address and an IP address of a local area network. The static IP address is outside the local area network.

The detecting module 206 detects whether a network cable connects to the internet jack 202. The IP address of the network cable is the external static IP address or is within the local area network.

When a network cable connects to the internet jack 202, the display module 210 displays an IP address setting interface. The IP address setting interface provides an interface to select the an IP address of the computer 200 as a network attribute either to the static IP address or to an IP address within the local area network. In response to the selection operation, the network attribute setting module 210 sets an IP address of the computer 200 to the static IP address or to an IP address of the local area network which is dynamically accessed.

The detecting module 208 further detects whether the IP address of the computer 200 connects successfully. When the IP address of the computer 200 does not connect, the display module 210 displays an unsuccessful connection alert.

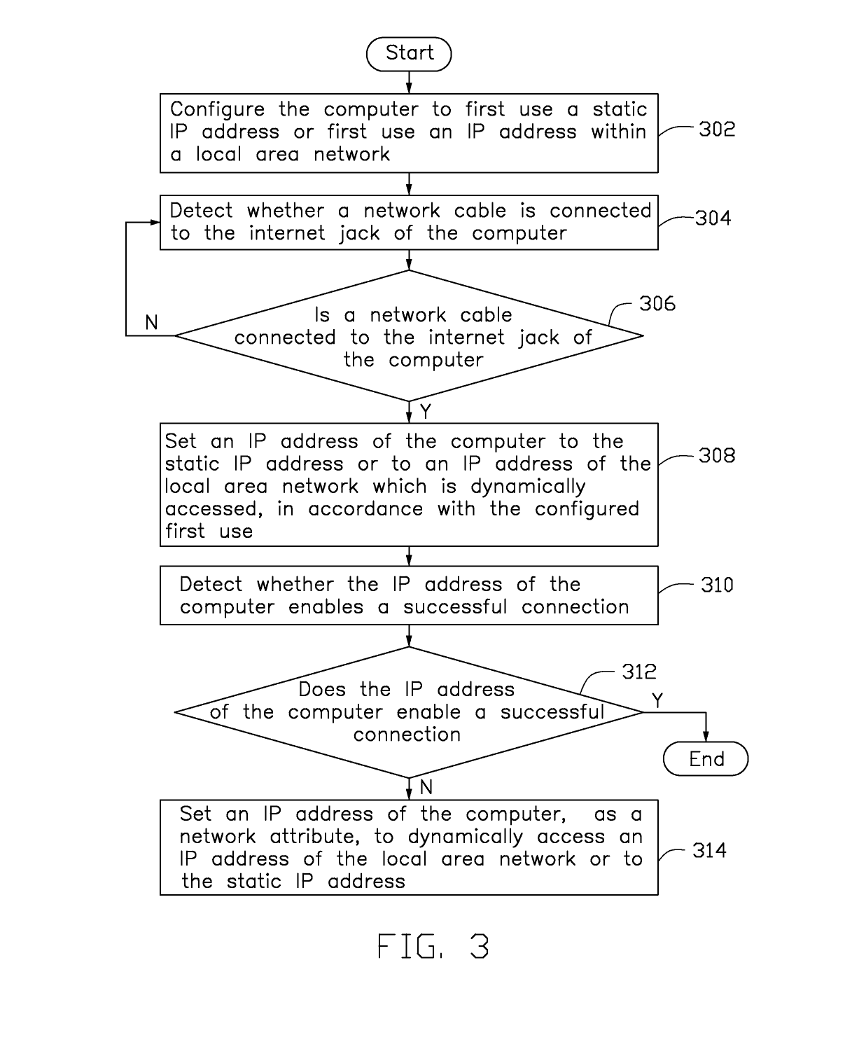

FIG. 3 illustrates a flowchart of a network attribute setting method according to an exemplary embodiment. The method is employed to the computer 100 to set an IP address of the computer 100 as a network attribute. The illustrated order of blocks in FIG. 3 is illustrative only and the order of the blocks can change. Additional blocks can be added or fewer blocks may be utilized without departing from this disclosure. The example method can begin at block 302.

At block 302, configure the computer 100 to first use a static IP address or to first use an IP address within a local area network. The static IP address is outside the local area network.

At block 304, detect whether a network cable is connected to the internet jack 102 of the computer 100.

At block 306, determine whether a network cable is connected to the internet jack 102 of the computer 100. If a network cable is connected to the internet jack 102, the procedure goes to step S308. Otherwise the procedure goes to step S304.

At block 308, set an IP address of the computer 100 to the static IP address or to an IP address of the local area network which is dynamically accessed, in accordance with the configured first use.

At block 310, detect whether the IP address of the computer 100 enables a successful connection.

At block 312, determine whether the IP address of the computer 100 enables a successful connection. If the IP address of the computer 100 does not enable a successful connection, the procedure goes to step S314. Otherwise the procedure ends.

At block 314, set an IP address of the computer 100 as a network attribute, to dynamically access an IP address of the local area network or to the static IP address.

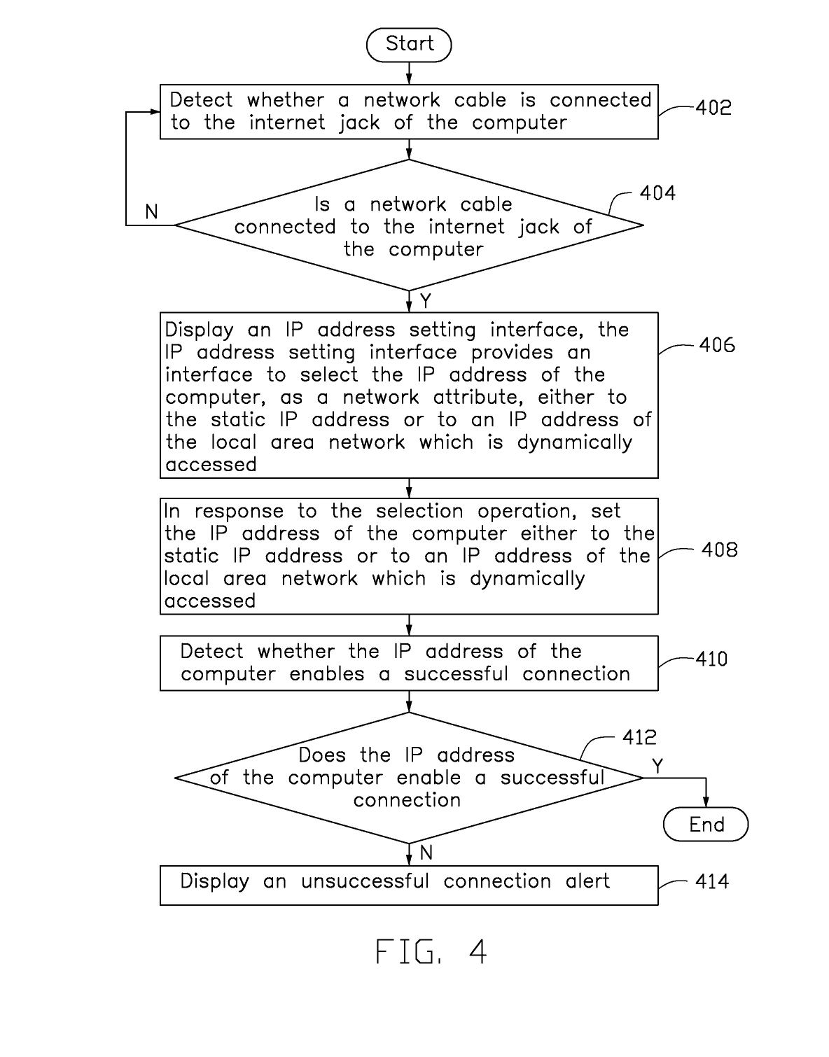

FIG. 4 illustrates a flowchart of a network attribute setting method according to another exemplary embodiment. The method enables the computer 200 to set an IP address of the computer 200 as a network attribute. The order of blocks in FIG. 4 is illustrative only and the order of the blocks can change. Additional blocks can be added or fewer blocks may be utilized without departing from this disclosure. The example method can begin at block 402.

At block 402, detect whether a network cable is connected to the internet jack 202 of the computer 200.

At block 404, determine whether a network cable is connected to the internet jack 202 of the computer 200. If a network cable is connected to the internet jack 202, the procedure goes to step S406. Otherwise the procedure goes to step S402.

At block 406, display an IP address setting interface. The IP address setting interface provides an interface to select the IP address of the computer 200, as a network attribute, either to the static IP address or to an IP address of the local area network which is dynamically accessed. The static IP address is outside the local area network.

At block 408, in response to the selection operation, set the IP address of the computer 200 either to the static IP address or to an IP address of the local area network which is dynamically accessed.

At block 410, detect whether the IP address of the computer 200 enables a successful connection.

At block 412, determine whether the IP address of the computer 200 enables a successful connection. If the IP address of the computer 200 does not enable a successful connection, the procedure goes to step S414. Otherwise the procedure ends

At block 414, display an unsuccessful connection alert.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A computer comprising:
an internet jack;
a detecting module configured to detect whether a network cable connects to the internet jack and detect whether an IP address of the computer enables successful connection;
a storage module storing data of IP addresses of a plurality of network cables, the stored data concerning IP addresses information comprising a static IP address and an IP address of a local area network, wherein the static IP address being outside the local area network; and
a network attribute setting module configured to set an IP address of the computer, as a network attribute, either to the static IP address or to an IP address of the local area network which is dynamically accessed until the IP address of the computer connects successfully.

2. The computer as claimed in claim 1, further comprising:
a priority setting module configuring the computer to first use the static IP address or to first use the IP address of the local area network.

3. The computer as claimed in claim 2, wherein when a network cable connects to the network jack, according to the IP address which is first used, the network attribute setting module sets the IP address of the computer, as a network attribute, to the static IP address or to the IP address of the local area network which is dynamically accessed.

4. The computer as claimed in claim 3, wherein when the network attribute IP address of the computer is set to the static IP address and the computer does not connects, the network attribute setting module sets the IP address of the computer to be dynamically accessed within the local area network.

5. The computer as claimed in claim 3, wherein when the network attribute IP address of the computer is set to be dynamically accessed within the local area network and the computer does not connect, the network attribute setting module sets the IP address of the computer to the static IP address as a network attribute.

6. The computer as claimed in claim 1, further comprising:
a display module configure to displays an IP address setting interface when a network cable connects to the internet jack, the IP address setting interface provides an interface to select the IP address of the computer as a network attribute either to the static IP address or to an IP address of within the local area network.

7. The computer as claimed in claim 6, wherein in response to the selection operation, the network attribute setting module sets the IP address of the computer to the static IP address or to an IP address of the local area network which is dynamically accessed.

8. The computer as claimed in claim 7, wherein when the IP address of the computer does not connect, the display module displays an unsuccessful connection alert.

9. A network attribute setting method comprising:
detecting whether a network cable is connected to the internet jack of the computer, wherein an IP address of the network cable is a static IP address or belongs to a local area network and the static IP address is outside the local area network;
detecting whether an IP address of the computer enables a successful connection; and
changing an IP address of the computer, as a network attribute, either to the static IP address or to an IP address of the local area network which is dynamically accessed until the IP address of the computer connects successfully.

10. The network attribute setting method as claimed in claim 9, further comprising:
configuring the computer to first use a static IP address or first use an IP address within a local area network; and
when a network cable connects to the internet jack, setting an IP address of the computer to the static IP address or to an IP address of the local area network which is dynamically accessed, in accordance with the configured first use.

11. The network attribute setting method as claimed in claim 9, further comprising:
when a network cable connects to the internet jack, displaying an IP address setting interface, the IP address setting interface providing an interface to select the IP address of the computer, as a network attribute, either to the static IP address or to an IP address of the local area network which is dynamically accessed; and
in response to the selection operation, setting the IP address of the computer either to the static IP address or to an IP address of the local area network which is dynamically accessed.

12. The network attribute setting method as claimed in claim 11, further comprising:
when the computer does not enable a successful connection, displaying an unsuccessful connection alert.
